(19) United States
(12) Patent Application Publication
(10) Pub. No.: US 2019/0380067 A1
(43) Pub. Date: Dec. 12, 2019

(54) COMMUNICATION SYSTEM

(71) Applicant: NOKIA SOLUTIONS AND NETWORKS OY, Espoo (FI)

(72) Inventors: Claudio ROSA, Randers (DK); Jari Petteri LUNDEN, Espoo (FI); Elena VIRTEJ, Espoo (FI); Frank FREDERIKSEN, Klarup (DK)

(21) Appl. No.: 16/483,140

(22) PCT Filed: Feb. 3, 2017
(86) PCT No.: PCT/EP2017/052403

§ 371 Date: Aug. 2, 2019

(51) Int. Cl. H04W 36/00

(52) U.S. Cl. CPC H04W 36/0016; H04W 36/0072; H04W 36/0061

(57) ABSTRACT

There is provided a method comprising: transmitting, by a source network apparatus to a target network apparatus prior to the target network apparatus receiving a message for initiating handover of a user apparatus to the target network apparatus, a request for a radio resource control configuration for use by the user apparatus when accessing the target network apparatus; receiving, by the source network apparatus, a response to the request; and forwarding, by the source network apparatus to the user apparatus, at least part of any radio resource control configuration information comprised in the response.

### FIELD

The present application relates to a method, apparatus, and computer program.

### BACKGROUND

A communication system can be seen as a facility that enables communication sessions between two or more entities such as user terminals, base stations/access points and/or other nodes by providing carriers between the various entities involved in the communications path. A communication system can be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link.

A user can access the communication system by means of an appropriate communication device or terminal. A communication device of a user is often referred to as user equipment (UE) or as a user apparatus. Throughout the following, these terms will be used interchangeably. A communication device is provided with an appropriate signal receiving and transmitting apparatus for enabling communications, for example enabling access to a communication network or communications directly with other users. The communication device may access a carrier provided by a station or access point, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP).

In order to increase the available spectrum, it has been proposed to use the unlicensed spectrum using for example some aspects of UTRAN and/or LTE technology.

### SUMMARY

According to a first aspect, there is provided a method comprising: transmitting, by a source network apparatus to a target network apparatus prior to the target network apparatus receiving a message for initiating handover of a user apparatus to the target network apparatus, a request for a radio resource control configuration for use by the user apparatus when accessing the target network apparatus; receiving, by the source network apparatus, a response to the request; and forwarding, by the source network apparatus to the user apparatus, at least part of any radio resource control configuration information comprised in the response.

The method may further comprise transmitting to the user apparatus a list of autonomous target network apparatuses, the list comprising an indication of which target network apparatuses have not configured any radio resources to the user apparatus for autonomous user apparatus handover.

According to a second aspect, there is provided a method comprising: receiving, by a target network apparatus, a request from a source network apparatus for a radio resource control configuration for use by a user apparatus when accessing the target network apparatus; determining, by the target network apparatus, whether or not to configure at least a partial radio resource control configuration for the user apparatus in a response to the request; and transmitting a response to the request in dependence on the determining.

Said determining may comprise determining the current load conditions of the target network apparatus.

In both of the above-mentioned aspects, the response may comprise one of: a complete radio resource control configuration; a partial radio resource control configuration; and no radio resource control configuration. The second aspect may further comprise: if the response comprises the complete radio resource control configuration: receiving a random access attempt from the user apparatus on at least some of the resources included in the response; and receiving a radio resource control connection reconfiguration complete message from the user apparatus, else if the response comprises the partial radio resource control configuration: receiving a random access attempt from the user apparatus on at least some of the resources included in the response; and receiving a radio resource control connection establishment request message from the user apparatus, else if the response comprises no radio resource control configuration: receiving a random access attempt from the user apparatus on at least some of the resources indicated in a system information broadcast by the target network apparatus; and receiving a radio resource control connection establishment request message from the user apparatus.

The request in both of the above-mentioned aspects may comprise an indication of a priority of a user apparatus. For the second aspect, the determining may further comprise using the priority to determine whether or not to configure at least a partial radio resource control configuration, such that a high priority user apparatus is more likely to be configured with at least a partial radio resource control configuration than a low priority user.

In both of the above-mentioned aspects, the request may be an implicit request that is provided via a request for the target network apparatus to allow an autonomous handover to be made by the user apparatus.

In both of the above-mentioned aspects, the request may comprise an indication of a degree of configuration information requested by the source network apparatus.

In both of the above-mentioned aspects, the request may comprise an indication of whether or not the user apparatus has already autonomously determined to initiate handover to the target network apparatus.

In both of the above-mentioned aspects, the request may be an implicit request for a radio resource control configuration for use by the user apparatus when accessing the target network apparatus.

According to a third aspect, there is provided a method comprising: receiving, by a user apparatus from a source network apparatus, an indication of a type of radio resource control configuration information for use by the user apparatus when accessing a target network apparatus; and selecting a signalling procedure to access the target network apparatus in dependence on the indication.

The indication may comprise one of: a complete radio resource control configuration; a partial radio resource control configuration; and no radio resource control configuration.

The method may further comprise: if the indication comprises the complete radio resource control configuration: performing random access on at least some of the resources included in the indication; and transmitting a radio resource control connection reconfiguration complete message to the target network apparatus, else if the indication comprises the partial radio resource control configuration: performing random access on at least some of the resources included in the indication; and transmitting a radio resource control connection establishment request message to the target network apparatus, else if the indication comprises no radio resource control configuration: performing random access on at least some of the resources indicated in a system information broadcast by the target network apparatus; and transmitting a radio resource control connection establishment request message to the target network apparatus.

The method may further comprise: determining that criteria for autonomous handover to the target network apparatus has been fulfilled subsequent to said receiving; and performing said selecting in dependence on said determining.

The method may further comprise receiving from the source network apparatus a list of autonomous target network apparatuses, the list comprising an indication of which target network apparatuses have not configured any radio resources to the user apparatus for autonomous user apparatus handover.

The method may further comprise using different triggering criteria for triggering autonomous handover to the target network apparatus in dependence on the received indication

The method may further comprise receiving the indication after an autonomous handover procedure to the target network apparatus has already been initiated by the user apparatus.

According to a fourth aspect, there is provided a computer program comprising computer executable instructions, which when executed by a computer, cause the computer to perform each of the method steps of any one of: claims 1-2 and 5, 7 and 9 to 12 when dependent on any of claims 1 and 2, or claims 3 to 6 and 7 to 12 when dependent on any one of claims 3 to 6, or claims 13 to 19.

According to a fifth aspect, there is provided an apparatus comprising at least one processor and at least one memory comprising code that, when executed by the at least one processor, causes the apparatus to perform each of the method steps of any one of: claims 1-2 and 5, 7 and 9 to 12 when dependent on any of claims 1 and 2, or claims 3 to 6 and 7 to 12 when dependent on any one of claims 3 to 6, or claims 13 to 19.

According to a sixth aspect, there is provided an apparatus comprising respective means for performing each of the method steps of any one of: claims 1-2 and 5, 7 and 9 to 12 when dependent on any of claims 1 and 2, or claims 3 to 6 and 7 to 12 when dependent on any one of claims 3 to 6, or claims 13 to 19.

According to a seventh aspect, there is provided an apparatus comprising at least one processor and at least one memory comprising code that, when executed by the at least one processor, causes the apparatus to: transmit, to a target network apparatus prior to the target network apparatus receiving a message for initiating handover of a user apparatus to the target network apparatus, a request for a radio resource control configuration for use by the user apparatus when accessing the target network apparatus; receive a response to the request; and forward, to the user apparatus, at least part of any radio resource control configuration information comprised in the response.

The apparatus may further be caused to transmit to the user apparatus a list of autonomous target network apparatuses, the list comprising an indication of which target network apparatuses have not configured any radio resources to the user apparatus for autonomous user apparatus handover.

According to an eighth aspect, there is provided an apparatus comprising at least one processor and at least one memory comprising code that, when executed by the at least one processor, causes the apparatus to: receive a request from a source network apparatus for a radio resource control configuration for use by a user apparatus when accessing the target network apparatus; determine whether or not to configure at least a partial radio resource control configuration for the user apparatus in a response to the request; and transmit a response to the request in dependence on the determining.

Said determining may comprise determining the current load conditions of the target network apparatus.

In both of the above-mentioned seventh and eighth aspects, the response may comprise one of: a complete radio resource control configuration; a partial radio resource control configuration; and no radio resource control configuration. The eighth aspect may further comprise: if the response comprises the complete radio resource control configuration: receiving a random access attempt from the user apparatus on at least some of the resources included in the response; and receiving a radio resource control connection reconfiguration complete message from the user apparatus, else if the response comprises the partial radio resource control configuration: receiving a random access attempt from the user apparatus on at least some of the resources included in the response; and receiving a radio resource control connection establishment request message from the user apparatus, else if the response comprises no radio resource control configuration: receiving a random access attempt from the user apparatus on at least some of the resources indicated in a system information broadcast by the target network apparatus; and receiving a radio resource control connection establishment request message from the user apparatus.

The request in both of the above-mentioned seventh and eighth aspects may comprise an indication of a priority of a user apparatus. For the eighth aspect, the determining may further comprise using the priority to determine whether or not to configure at least a partial radio resource control configuration, such that a high priority user apparatus is more likely to be configured with at least a partial radio resource control configuration than a low priority user.

In both of the above-mentioned seventh and eighth aspects, the request may be an implicit request that is provided via a request for the target network apparatus to allow an autonomous handover to be made by the user apparatus.

In both of the above-mentioned seventh and eighth aspects, the request may comprise an indication of a degree of configuration information requested by the source network apparatus.

In both of the above-mentioned seventh and eighth aspects, the request may comprise an indication of whether or not the user apparatus has already autonomously determined to initiate handover to the target network apparatus.

In both of the above-mentioned seventh and eighth aspects, the request may be an implicit request for a radio resource control configuration for use by the user apparatus when accessing the target network apparatus.

According to a ninth aspect, there is provided an apparatus comprising at least one processor and at least one memory comprising code that, when executed by the at least one processor, causes the apparatus to: receive, from a source network apparatus, an indication of a type of radio resource control configuration information for use by the apparatus when accessing a target network apparatus; and select a signalling procedure to access the target network apparatus in dependence on the indication.

The indication may comprise one of: a complete radio resource control configuration; a partial radio resource control configuration; and no radio resource control configuration.

The apparatus be further be caused to: if the indication comprises the complete radio resource control configuration: perform random access on at least some of the resources included in the indication; and transmit a radio resource control connection reconfiguration complete message to the target network apparatus, else if the indication comprises the partial radio resource control configuration: perform random access on at least some of the resources included in the indication; and transmit a radio resource control connection establishment request message to the target network apparatus, else if the indication comprises no radio resource control configuration: perform random access on at least some of the resources indicated in a system information broadcast by the target network apparatus; and transmit a radio resource control connection establishment request message to the target network apparatus.

The apparatus may be further caused to: determine that criteria for autonomous handover to the target network apparatus has been fulfilled subsequent to said receiving; and perform said selecting in dependence on said determining.

The apparatus may be further caused to receive from the source network apparatus a list of autonomous target network apparatuses, the list comprising an indication of which target network apparatuses have not configured any radio resources to the user apparatus for autonomous user apparatus handover.

The apparatus may be further caused to use different triggering criteria for triggering autonomous handover to the target network apparatus in dependence on the received indication

The apparatus may be further caused to receive the indication after an autonomous handover procedure to the target network apparatus has already been initiated by the user apparatus.

### DESCRIPTION OF FIGURES

Embodiments will now be described, by way of example only, with reference to the accompanying Figures in which:

FIG. 1 shows a schematic diagram of an example communication system comprising a plurality of base stations and a plurality of communication devices;

FIG. 2 shows a schematic diagram of an example mobile communication device;

FIGS. 3 to 5 are flow diagrams of operations that may be performed by the different interrelated apparatuses; and

FIGS. 6 to 8 are signalling diagrams in accordance with different examples.

### DETAILED DESCRIPTION

In general, the following disclosure relates to making handover of a user apparatus from a source network apparatus to a target network apparatus more efficient. The following disclosure has particular use to autonomous user apparatus handovers i.e. handovers to the target network apparatus that are initiated by the user apparatus when the user apparatus determines that the requisite condition(s) for handover have been met.

In particular, there is provided a source network apparatus that is configured to if possible, preconfigure the user apparatus with radio resource control configuration information that is suitable for use by the user apparatus when initiating handover with the target network apparatus to establish a connection with the target network apparatus. The radio resource control configuration information may be received by the source network apparatus from the target network apparatus in response to a request (either implicit or explicit) for a radio resource control configuration for this purpose. An implicit request may be, for example, a request to the target network apparatus to allow autonomous handover by the user apparatus, where the target network is configured to be able to respond to the autonomous handover request with any radio resource control configuration information desired, by the target network apparatus, to be provided to the user apparatus.

If a full or partial radio resource control configuration (discussed further below) is provided to a user apparatus in advance of an actual handover initiation, then when the handover conditions are triggered in the user apparatus, the user apparatus may readily access the target network apparatus using the provided radio resource control configuration and a given signalling mechanism. The signalling mechanism may differ depending on whether a full or partial radio resource control configuration has been received by the user apparatus. The signalling mechanism may thus depend on the extent of radio resource control configuration information provided to the user apparatus, as discussed further below in particular examples.

If no radio resource control configuration is supplied to the user apparatus in advance of the condition for handover being met, the user apparatus may instead choose some alternate signalling mechanism for executing a handover from the source network apparatus to the target network apparatus. In other words, depending on the type of configuration information (if any) supplied to the user apparatus, the user apparatus may select an appropriate signalling mechanism for effectuating the handover. Such mechanisms of preconfiguring a user apparatus with at least part of a radio resource control configuration for accessing a target network apparatus and customised signalling mechanisms for use with the different types of preconfigured radio resource control information provided both aid in reducing unnecessary handover delays in the communications network.

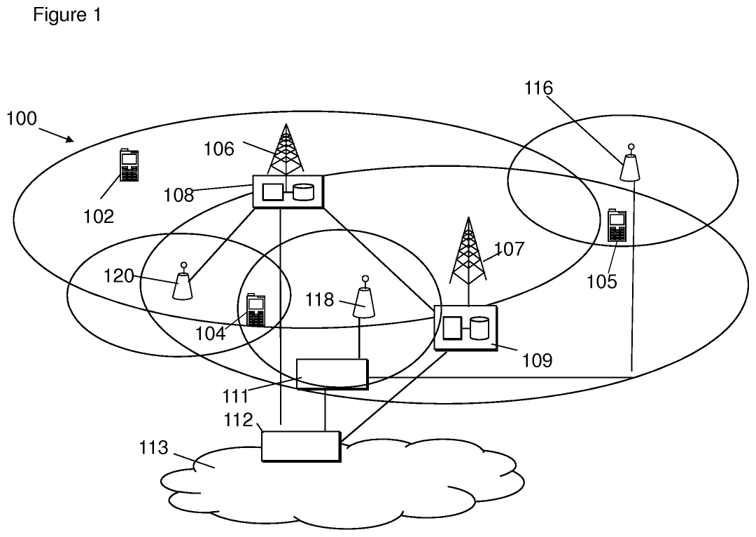

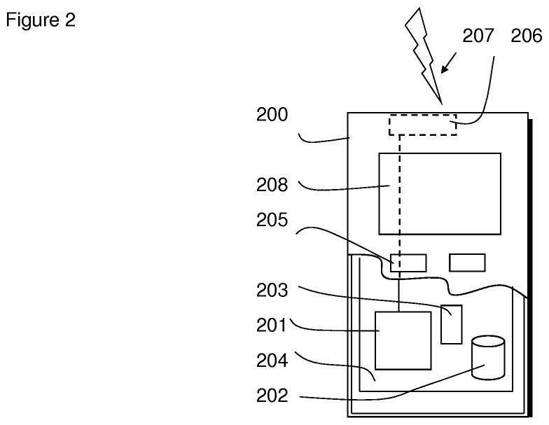

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user apparatus (UE) 102, 104, 105 are provided wireless access via at least one base station or similar wireless transmitting and/or receiving node or point. A base station is referred to as an eNodeB (eNB) in LTE, and may be referred to more generally as simply a network apparatus or a network access point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each user apparatus is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In an LTE system, radio resource control (RRC) is defined to be a sublayer of radio interface Layer 3 that exists in the control plane only, and which provides information transfer service to the non-access stratum (see 3GPP Technical Specification Group Services and System Aspects 21.905). RRC is a protocol layer between a user apparatus and an eNB, and is in charge of, for example, paging the user apparatus when traffic comes, establishing/maintaining or release of radio bearers (establishing an RRC connection between user apparatus and eNB), user apparatus mobility, user apparatus measurement configuration and user apparatus reporting configuration, etc. RRC is responsible for controlling the configuration of radio interface Layers 1 and 2.

According to 3GPP Technical Specification 36.331 V14.0.0 (2016 September), in LTE, RRC protocol offers the following services to upper layers: Broadcast of common control information; Notification of user apparatuses in RRC_IDLE, e.g. about a terminating call, for Earthquake and Tsunami Warning system (ETWS), for Commercial Mobile Alert System (CMAS); Transfer of dedicated control information, i.e. information for one specific user apparatus. The RRC protocol includes the following main functions: Broadcast of system information (Including non-access stratum (NAS) common information), RRC connection control (Paging, Establishment/modification/suspension/resumption/release of RRC connection, including e.g. assignment/modification of user apparatus identity (e.g. the cell-radio network temporary identifier (C-RNTI)), establishment/modification/release of Signalling radio bearers (SRBs) SRB1, SRB1bis and SRB2, access class barring; Initial security activation, i.e. initial configuration of Access Stratum integrity protection (SRBs) and access stratum ciphering (SRBs, data (user) radio bearers (DRBs)); RRC connection mobility including e.g. intra-frequency and inter-frequency handover, associated security handling, i.e. key/algorithm change, specification of RRC context information transferred between network apparatuses; Establishment/modification/release of radio bearers carrying user data (DRBs); Recovery from radio link failure; Measurement configuration and reporting etc.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, base stations 116 and 118 are connected via a gateway 111 whilst station 120 connects via the controller apparatus 108. In some embodiments, the smaller stations may not be provided.

A possible mobile communication device will now be described in more detail with reference to FIG. 2 showing a schematic, partially sectioned view of a communication device 200. Such a communication device is often referred to as user apparatus (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto. The communication devices 102, 104, 105 may access the communication system based on various access techniques.

An example of wireless communication systems are architectures standardized by the 3rd Generation Partnership Project (3GPP). A latest 3GPP based development is often referred to as the long term evolution (LTE) or LTE Advanced Pro of the Universal Mobile Telecommunications System (UMTS) radio-access technology. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Recently, developments have been made in Multefire. Multefire is a system based on LTE-like radio access technology that is designed for stand-alone deployments in the unlicensed spectrum.

In a Multefire system (and more generally with LTE stand-alone operation in unlicensed band), communications between the user apparatus and a network apparatus is subject to channel clearance. In other words, communications between the user apparatus and a network apparatus may only be performed (at least initially) when a channel being used for transmissions between the two entities has not been used for a predetermined time immediately preceding the transmission, or is not currently being used at the point in time at which an communication is initiated. In particular, a listen-before-talk (LBT) procedure may be implemented. Hence, any message exchanged between a network apparatus such as an eNB and a user apparatus is subject to LBT/the channel being clear.

This is different to networks operating on licensed spectrum(s), such as some legacy LTE systems. This is because the communication devices in such licensed spectrums are always assigned resources that are guaranteed to enable their access to the medium. In legacy LTE, the transmission of control messages is always guaranteed, regardless of a level of interference on the communication channel. Therefore, problems arising from accessing the medium due to LBT procedure failing to get access to a free/clear channel was never an issue in such systems.

In contrast, in systems like Multefire, that operate on an unlicensed spectrum, strict coexistence regulations needing to be fulfilled, such as LBT succeeding prior to any message or data being sent in either the uplink or the downlink. Only if the channel is clear will data be transmitted. Similar issues may affect other types of communication systems. For example, in other systems, there may be only one-way LBT, meaning that only one end of the transmission link needs to do LBT, but still the availability of the radio channel would not be guaranteed.

As a result of these coexistence regulations, the mobility robustness of such systems may be compromised if the LBT procedure blocks or causes delays in the transmission of radio resource management measurements or handover related signalling messages. This may have knock-on problems, such as the handover event triggering arriving too late at the source network apparatus, the measurement report transmission not succeeding or being delayed, and/or the handover command to the user apparatus not being received by the user apparatus in time (this may be, for example, if the radio link quality has deteriorated so much that the user apparatus is no longer able to receive it correctly).

To negate these problems, user apparatus autonomous handover is proposed to enhance the mobility performance of MulteFire and other such systems.

The present invention is not limited to LTE or MulteFire systems, but can be applied in other systems as well. The described procedure(s) may be also applied in an LTE system operating stand-alone on unlicensed band, or in 5G or New Radio.

The Multefire Alliance (MFA) recently agreed to study user apparatus autonomous mobility as one of the enhancements for Multefire Alliance release 1.1. User apparatus autonomous handover is the initiation by a user apparatus of a handover from a source cell to a target cell in response to a determination by the user apparatus that criteria for initiating the handover has been fulfilled. The criteria may be configured dynamically, i.e. whilst the system is operating. The criteria may be set by a communications protocol in advance of the user apparatus communicating with the network.

Thus, with user apparatus autonomous mobility/handover, a user apparatus can autonomously initiate the random access procedure towards the target cell for initiating handover/connection establishment without first successfully completing the handover signalling with the source network apparatus. It is understood, however, that the source network apparatus may still be informed that the user apparatus may be in the process of executing an autonomous handover towards a target network apparatus, or is configured to execute an autonomous handover when the above-mentioned handover criteria are determined to be met. Thus the source network target network apparatus may also determine, without prior signalling to this effect from the user apparatus, that the user apparatus is likely to execute a handover in the immediate future. In these conditions, in response to an indication from the user apparatus that the autonomous handover is initiated or is likely to be initiated soon, the source network apparatus may decide to initiate the autonomous handover preparation. For example, the source network apparatus may decide to initiate the autonomous handover reception upon reception of such indication from the user apparatus. The autonomous handover preparation is initiated in case, for example, the corresponding target network apparatus was not previously prepared.

Alternatively, the source network apparatus may decide to prepare one or more target network apparatuses in advance for user apparatus autonomous mobility by providing user apparatus context information to the one or more target network apparatuses in advance.

The present teachings provide techniques directed towards improving the efficiency of processes associated with a user apparatus initiating handover from a source network apparatus to a target network apparatus. These techniques will be first discussed in a very general manner, before looking at particular embodiments. It is understood that the application of such techniques may not be limited to only autonomous user initiated handover scenarios.

The inventors have realised that, in both of the cases mentioned above, the source network apparatus may usefully prepare one or more target network apparatuses and a user apparatus for user apparatus autonomous handover by requesting from the target network apparatus (and subsequently forwarding to the user apparatus) information usable for connection establishment between the user apparatus and the target network apparatus in advance of such a connection establishment being initiated by the user apparatus. An example of such information is radio resource control configuration information. The inventors have further realised that, depending on the radio resource availability of the target network apparatus, the target network apparatus may decide to pre-allocate a radio resource control configuration (either in whole or in part) for the user apparatus to use in establishing a connection with the target network apparatus during the autonomous handover. Alternatively, the target network apparatus may determine to delay the allocation of the radio resource configuration until a time at which the criteria for handover is determined by the user apparatus to have been met.

The proposed system aims at providing increased flexibility in the user apparatus autonomous handover configuration. This is effectuated by providing an opportunity to the target network apparatus to optimize the handover signalling by determining whether or not to preconfigure at least part of a radio resource control configuration for a user apparatus. This determining may be made by the target network apparatus in dependence on instantaneous network conditions such as load, interference, etc.

The source network apparatus may be configured to send a message to the target network apparatus that, either implicitly or explicitly, indicates to the target network apparatus that a radio resource control configuration (either in full or in part) may be provided to a user apparatus by the target network apparatus in advance of a connection establishment being requested by the user apparatus to the target network apparatus.

For some target network apparatuses it is possible that target network apparatus does not provide any radio resource control configuration for a user apparatus in advance of a connection establishment. In this case the user apparatus may obtain the configuration directly from the target network apparatus during the autonomous handover procedure (i.e. when a connection establishment is requested by the user apparatus to the target network apparatus).

An example of implicit signalling is now discussed. The source network apparatus may be configured to initiate signalling towards the target network apparatus by sending an autonomous handover request message. This handover request message may be a different message than the (legacy) X2AP HANDOVER REQUEST MESSAGE that is used to initiate a handover from the source network apparatus to the target network apparatus in some current LTE systems. The target network apparatus is configured to identify the autonomous handover request message as being a message to which radio resource configuration information may be provided in response for use in handovers. This may be, for example, because the handover request message is different to other (e.g. existing) forms of the handover request message used in the current LTE-like systems. Thus the handover request message received by the target network apparatus may constitute an implicit request for assigning radio resource control configuration information for a user apparatus for executing an autonomous handover. Depending on whether the source network apparatus is pre-configuring a potential target network apparatus for autonomous mobility, or simply initiating the autonomous handover procedure towards an unprepared target network apparatus (for example as signalled in existing LTE-like systems using an SN Status Transfer X2AP procedure), the new autonomous handover request message may comprise different information.

On receipt of this message, the target network apparatus may thus determine that the handover request message (or the like) may be responded to with an autonomous handover request acknowledge message, including for example a radio resource configuration for the user apparatus i.e. that resources may be reserved for the user apparatus to use in establishing a connection with the target network apparatus.

The radio resource configuration may be reserved for use by the user apparatus for only a limited time window. The length of the time window may be set in any one of a number of ways. One example of which would be the length of the window being set by the operating communication protocol of the target network apparatus.

The target network apparatus may respond to the handover request message (or the like). The response may comprise an indication of whether or not any resources have been allocated to the user apparatus by, respectively, a provision or absence of radio resource configuration control information in the response to the source network apparatus. If any radio resource configuration control information is provided, it may be provided in the response. This radio resource configuration control information may be subsequently provided to the user apparatus for use in establishing a connection with the target network apparatus in the event an autonomous handover event is triggered at the user apparatus in response to predetermined criteria being met.

At the user apparatus side, the user apparatus may be configured to receive a message from the source network apparatus. The message may indicate to the user apparatus that the user apparatus may execute autonomous handover to the target network apparatus. The message may comprise or may not comprise at least some radio resource control configuration information for use by the user apparatus for communicating with the target network apparatus. The provision of this radio resource control configuration information, or lack thereof, may implicitly indicate a type of radio resource control configuration signalling procedure for use by the user apparatus when accessing the target network apparatus. For example, if the message comprises a complete/full radio resource configuration control information, this may indicate that a first type of signalling procedure should be used for executing autonomous handover. If the message comprises a partial radio resource configuration control information, this may indicate that a second type of signalling procedure should be used for executing autonomous handover. If the message does not comprise any radio resource configuration control information, this may indicate that a third type of signalling procedure should be used. The first, second and third types of signalling procedures may all be different signalling procedures to each other.

In an example, upon triggering of the autonomous handover procedure (which is subsequent to/after receipt of the provided radio resource control configuration information mentioned above) and depending on the target network apparatus radio resource control configuration that was signalled as part of the autonomous handover configuration message, the user apparatus may select one of the following signalling procedures. These signalling procedures are written utilising terminology of current LTE message exchange, and are labelled as a) to c) immediately below. However, it is understood that the use of this terminology is not limiting, and is instead meant to illustrate a possible use case. The signalling procedures may be adapted to other systems which have to deal with similar communication methods as LTE on unlicensed band, subject to LBT success. It is further understood that, in general, the signalling procedure selected by the user apparatus for initiating an autonomous handover to the target network apparatus is selected in dependence on the presence of and/or degree of radio resource control configuration information provided to the user apparatus during the preconfiguration stage (discussed above).

a) In one example, the user apparatus may perform random access procedure on the resources signalled in MobilityControlInfo, and send RRCConnectionReconfigurationComplete message to the target cell.

b) In another example, the user apparatus may perform random access procedure on resources signalled in MobilityControlInfo, and send to the target network apparatus a message similar to (or same as) RRCConnectionReestablishmentRequest message, followed by a message from the target cell to the user apparatus similar to (or same as) RRCConnectionReestablishment message including, among other information, radio ResourceConfig Dedicated.

c) In another example, the user apparatus may perform random access procedure on resources acquired by reading the system information of the target cell, and send to the target network apparatus a message similar to (or same as) RRCConnectionReestablishmentRequest message, followed by a message from the target cell to the user apparatus similar to (or same as) RRCConnectionReestablishment message including, among other information, radio ResourceConfig Dedicated.

In an example, the source network apparatus may be configured to explicitly indicate to the user apparatus (e.g. in the radio resource control configuration message carrying the user apparatus autonomous handover configuration) that the target network apparatus is prepared or is unprepared for handover. The target network apparatus is considered to be unprepared for handover when no (i.e. not even partial) radio resource control configuration information for the target network apparatus is included. The target network apparatus is considered to be prepared for handover when at least partial radio resource control configuration information for the target network apparatus is included. In this way the user apparatus can distinguish between target network apparatuses that are prepared or not prepared for a user apparatus initiated handover, and hence what access signalling should be used by the user apparatus to initiate handover with the target network apparatus.

Thus the user apparatus may, in dependence on the indication (i.e. the provision, or lack thereof, of at least partial radio resource control configuration information), select a signalling procedure to access the target network apparatus.

In another example, the autonomous handover request from the source network apparatus to the target network apparatus may also include an indication of a level of radio resource control configuration preferred by the source network apparatus. In other words, the source network apparatus may indicate whether a complete/full configuration is preferred, a partial configuration is preferred, or no configuration is preferred. Such an indication may be needed depending, for example, on the source network apparatus conditions. For example, the need for such a preference indication may depend on at least one of: the number of target network apparatuses that needs configuration; the target amount of data for configuration of the user apparatus; the expected time duration until an expected autonomous handover; a subscription level of the user apparatus; and the user apparatus capabilities (e.g. to store full configuration of multiple target cells). In another example, the indication of the preferred level of configuration could be potentially determined by taken into account any combination of the above listed conditions.

In another example, the request from a source network apparatus for a radio resource control configuration for use by a user apparatus when accessing the target network apparatus may also include some information/indication of “importance” of the user. That is, some users may have preference/priority over others. Priority/preference may be defined, for example (but not limited to), through subscription and/or proximity to the target network apparatus.

In another example, the request from a source network apparatus may be either a request to perform an autonomous handover or a request for an autonomous handover configuration (for example partial/full RRC configuration to be used by the user apparatus when accessing the target network apparatus).

In another example, during the (autonomous) handover configuration, the user apparatus receives the configuration and stores it. The actual autonomous handover takes place when other metrics are in place (not controlled by the target network apparatus). This may be at a substantially later time. The user apparatus may store one or more configurations corresponding to different potential target network apparatuses. If the autonomous handover triggering conditions are fulfilled for a certain target network apparatus, then the user apparatus may trigger the autonomous handover to the corresponding target network apparatus and apply the corresponding stored configuration.

A radio resource control message subsequently used by the source network apparatus to configure the user apparatus with autonomous handover towards a target network apparatus or a set of target cells may include at least one of above-mentioned radio resource control configurations for the target network apparatus.

An alternative way of looking at the above described system operation is now described with reference to particular examples.

First, the source network apparatus may decide to pre-configure one (or more) target network apparatuses for autonomous handover mobility. The source network apparatus may therefore initiate the autonomous user apparatus handover preparation procedure.

To initiate the autonomous user apparatus handover preparation procedure, the source network apparatus may send an autonomous handover request message to the target network apparatus. As mentioned above, the autonomous handover request message may implicitly indicate the request is for a user apparatus autonomous handover that may or may not happen within a given time window. The length of such a time window may be explicitly indicated in the request message from the source to the target and/or in the acknowledge message from the target to the source. The length of such a time window may be implicitly determined by specifications, or it may be an indeterminate time window (i.e. valid until the autonomous hand over configuration is explicitly released by either the source or the target network apparatus).

The target network apparatus may reply with either an acknowledgement or with a failure message. If the target network apparatus responds with an acknowledgement message, the target network apparatus may include in the acknowledgement message:

a) a full radio resource control configuration for the target network apparatus. This may be defined according to a governing communication protocol specification. In one example current communication protocol specification, the full radio resource control reconfiguration information comprises MobilityControlInfo and the set of resource control reconfiguration information that a user apparatus should use in the target cell; or
b) a partial radio resource control configuration for the target network apparatus, (for example, only including MobilityControlInfo); or
c) no radio resource control configuration at all.

When configuring the user apparatus for autonomous mobility towards a target network apparatus, the source network apparatus may be configured to transparently transfer the radio resource control configuration it has received from the target network apparatus to the user apparatus. This situation may be compared to situations in which the target network apparatus has been previously prepared with X2AP autonomous handover preparation procedure.

It should be noted that the (a), (b) and (c) in the above paragraphs could act as “pairs”, meaning that, for example, if (a) is signalled, the subsequent procedure for handover also follows (as a general principle) the (a) procedure described further above.

If the target network apparatus has not been previously prepared, the source network apparatus may be configured to configure the user apparatus for autonomous handover operation without any radio resource control configuration for accessing the target network apparatus. However, the source network apparatus may still indicate to the user apparatus that the target network apparatus is prepared for autonomous handover.

At the user apparatus side, when the criteria for user apparatus autonomous handover towards a target network apparatus are met, the user apparatus may initiate handover to the target network apparatus. The handover may be executed in using different signalling procedures in dependence on the type (if any) of radio resource control configuration information the user apparatus has been provided with. For example, if the user apparatus is configured with full or partial radio resource control configuration for the target network apparatus including at least MobilityControlInfo, the user apparatus may be configured to use the information in MobilityControlInfo to perform the random access procedure towards the target network apparatus. Else, if the user apparatus is not configured with any radio resource control configuration for the target network apparatus, the user apparatus shall read the relevant information (e.g. from a system information broadcasted by the target network apparatus) to perform random access towards the target network apparatus from the system information of the target network apparatus.

After having performed the random access procedure towards the target network apparatus, the user apparatus may again be configured to execute different signalling procedures in dependence on the type of radio resource control information provided to the user apparatus (i.e. full, partial, or zero radio resource control information). For example, if the user apparatus is allocated a complete and valid radio resource control configuration to be used in the target network apparatus, the user apparatus may be configured to send a message to the target network apparatus that indicates that handover has been successfully executed. A suitable message for this would be, for example, the RRCConnectionReconfigurationComplete message that is currently sent to the target base station as in legacy/existing LTE handover procedure. In the example case given, the RadioConnectionReconfigurationComplete message is a message type that is currently in use in the radio resource control protocol. Its specific mention here (and later in the description) is simply to provide an illustrative example of a message that may be used to indicate that a connection has been set up between the user apparatus and the target network apparatus. It is understood that other messages may be used to indicate that a connection has been set up between the user apparatus and the target network apparatus.

In another example, if the user apparatus has not been allocated a valid radio resource control configuration to be used in the target network apparatus (i.e. only a partial radio resource control configuration or no radio resource control configuration has been received), then the user apparatus may be configured to send an autonomous handover request message to the target network apparatus. This autonomous request message may comprise, for example, among other information, the cell ID of the source network apparatus and the user apparatus ID. The target network apparatus may either accept this message request (for example including the radio resource control configuration) or reject this message request. This could be followed by a RadioConnectionReconfigurationComplete message from the user apparatus to the target network apparatus. An example message for accepting the autonomous request message may comprise the radio resource control configuration information for the user apparatus to access the target network apparatus. An example legacy/existing LTE-type message that mat be used to signal an accept is a radioResourceConfigDedicate message. The radioResourceConfigDedicate message is a message type that is currently in use in the radio resource control protocol. Its specific mention here is simply to provide an illustrative example of a message that may be used to indicate that a connection has been set up between the user apparatus and the target apparatus. In response to receiving an acceptance message, the user apparatus may be configured to transmit a message to the target network apparatus indicating that handover is completed. An example message type from existing/legacy LTE-types systems is the radio resource control reconfiguration complete message sent from the user apparatus to the target network apparatus B (as per the above). This signalling procedure is similar to (if not the same as) the signalling procedure used for the re-establishment procedure in some existing LTE-based systems.

An advantage of transmitting an indication from the source network apparatus to the target network apparatus that a radio resource configuration for a handover may be required (e.g. for autonomous user apparatus handover), is that the target network apparatus may do a “light” handover preparation instead of full preparation, such that only some resources are reserved instead of all necessary resources for establishing communications between the target network apparatus and the user apparatus. Thus a benefit is that if the target network apparatus already has a high load, the target network apparatus can avoid reserving excessive resources (e.g. for the random access channel) beforehand, whilst still providing some resources to mitigate against some of the currently proposed LBT mechanisms.

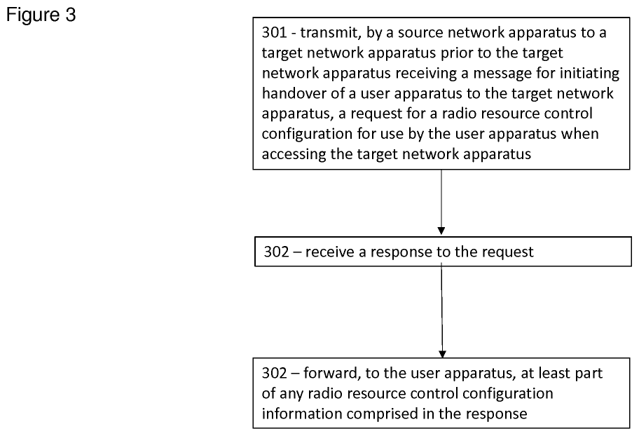

The following describes potential actions of each of the source apparatus, target apparatus and user apparatus with reference to the flow charts of FIGS. 3 to 5.

FIG. 3 is a flow chart illustrating potential operations performed by the source network apparatus.

At 301, the source network apparatus is configured to transmit, to a target network apparatus, a request for a radio resource control configuration for use by a user apparatus when accessing the target network apparatus.

The request may be a request for the target network apparatus to allow an autonomous handover request from the user apparatus.

The autonomous handover request may comprise an indication of a degree of configuration information requested by the source network apparatus. Moreover, the autonomous handover request could include on some level an indication of the preferred level of response (full configuration, partial configuration, or just admission control and store user apparatus context). This may be based on, for example, the number neighbour cells being prepared and/or the expected time until the autonomous handover.

In an example, the source network apparatus may be configured to explicitly indicate to the user apparatus (for example, in the radio resource control configuration message carrying the user apparatus autonomous handover configuration) that the target network apparatus is prepared or not prepared, when no (or not even partial) radio resource control configuration for the target network apparatus is included. By providing the user apparatus with such an explicit indication, the user apparatus may distinguish between target network apparatuses that are prepared and target network apparatuses that not prepared. The autonomous handover procedure and triggering rules may be configured in the user apparatus such that the user apparatus treats prepared target network apparatuses differently to and unprepared target network apparatuses. For example, the user apparatus may be configured to not signal the source network apparatus before initiating an autonomous handover if the target network apparatus is prepared, but to signal the source network apparatus before initiating an autonomous handover if the target cell is not prepared. Different triggering criteria (e.g. threshold or time to trigger setting) could be also used for prepared vs. unprepared network apparatuses. Similarly, different triggering rules may be applied by the user apparatus depending on the degree of RRC configuration provided by the target network apparatus (i.e. full, partial, or none).

In an example, the autonomous handover request message may comprise an indication of whether or not the user apparatus has already autonomously initiated handover to the target network apparatus.

In another example, the autonomous handover request message to the target network apparatus, may comprise an indication from the source network apparatus as to whether or not the requested response is a pre-configuration.

At 302, the source network apparatus is configured to receive a response to the request.

The response may comprise one of: a complete radio resource control configuration; a partial radio resource control configuration; and no radio resource control configuration.

At 303, the source network apparatus is configured to forward, to the user apparatus, at least part of any radio resource control configuration information comprised in the response.

The source network apparatus may be further configured to transmit, to the user apparatus, a list of autonomous target network apparatuses, the list comprising an indication of which target network apparatuses have not configured any radio resources to the user apparatus for autonomous user apparatus handover.

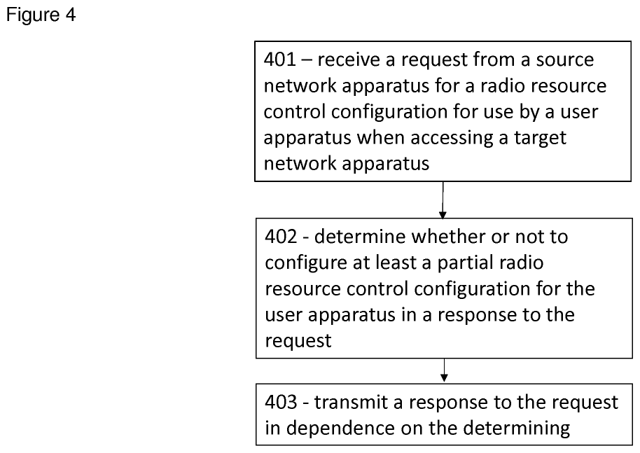

FIG. 4 is a flow chart illustrating potential operations performed by the target network apparatus.

At 401, the target network apparatus is configured to receiving a request from a source network apparatus for a radio resource control configuration for use by a user apparatus when accessing the target network apparatus. The request may be as detailed above in relation to FIG. 3.

At 402, the target network apparatus is configured to determine whether or not to configure at least a partial radio resource control configuration for the user apparatus in a response to the request. This determination may be made in dependence on a variety of different factors. One factor may be the current load on the network resources available for use by the target network apparatus. In this case, the higher the load, the less likely the target network apparatus is to provide a resource configuration (either full or partial) to the user apparatus. Another factor may be whether or not the user apparatus has already initiated handover to the target network apparatus (with the target network apparatus being more likely to provide at least a partial radio resource control configuration for the user apparatus if the user apparatus has already autonomously initiated handover that if the user apparatus has not already initiated handover). Other factors are also possible. Any of the factors may be applied by the target network apparatus either alone or in combination with other factors. Information relating to the different factors may be provided in the request message of 401.

At 403, the target network apparatus is configured to transmit a response to the request in dependence on the determining.

The response may be as detailed above in relation to FIG. 3.

If the response comprises the complete radio resource control configuration, the target network apparatus is configured to receive a random access attempt from the user apparatus on at least some of the resources included in the response. The target network apparatus is further configured to receive an indication from the user apparatus that the user apparatus has completed setup of the radio resource control connection immediately subsequent to the random access attempt.

If the response comprises only a partial radio resource control configuration, the target network apparatus is similarly configured to receive a random access attempt from the user apparatus on at least some of the resources included in the response. However, in contrast to the case in which a full radio resource configuration was provided, the target network apparatus is configured to subsequently receive message from the user apparatus requesting that a radio resource control connection be established.

If the response comprises no radio resource control configuration, the target network apparatus is configured to receive a random access attempt from the user apparatus on at least some of the resources indicated in a system information broadcast by the target network apparatus. The target network apparatus is further configured to receive a radio resource control connection establishment request message from the user apparatus, as per the case when a partial radio resource control configuration is provided.

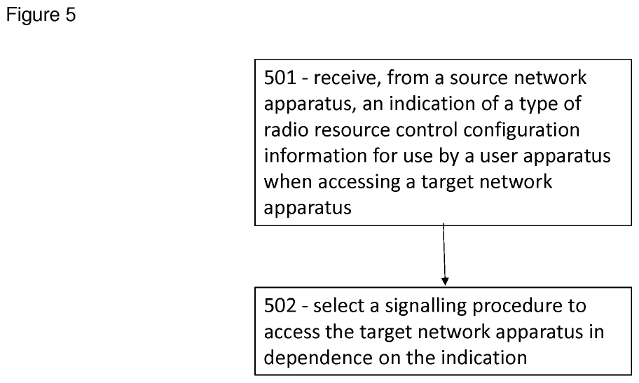

FIG. 5 is a flow chart illustrating various mechanisms performed by a user apparatus.

At 501, the user apparatus is configured to receive, from a source network apparatus, an indication of a type of radio resource control configuration information for use by the user apparatus when accessing a target network apparatus. The type may be signalled to the user apparatus either implicitly or explicitly, using the message descried above in relation to step 303.

At 402, the user apparatus is configured to select a signalling procedure to access the target network apparatus in dependence on the indication.

As mentioned in the case above, the indication may comprise any of: a complete radio resource control configuration; a partial radio resource control configuration; and no radio resource control configuration.

If the indication comprises the complete radio resource control configuration, the user apparatus is further configured to perform random access on at least some of the resources included in the indication; and to transmit a radio resource control connection reconfiguration complete message to the target network apparatus, as described above in relation to FIG. 4.

If the indication comprises the partial radio resource control configuration, the user apparatus is configured to perform random access on at least some of the resources included in the indication; and to transmit a radio resource control connection establishment request message to the target network apparatus, as described above in relation to FIG. 4.

If the indication comprises no radio resource control configuration, the user apparatus is configured to perform random access on at least some of the resources indicated in a system information broadcast by the target network apparatus; and to transmit a radio resource control connection establishment request message to the target network apparatus, as described above in relation to FIG. 4.

The user apparatus may be further configured to determine that criteria for autonomous handover to the target network apparatus has been fulfilled subsequent to said receiving; and to perform said selecting in dependence on said determining. In other words, the user apparatus may be configured to receive an indication of a radio resource control configuration to be used for accessing the target network apparatus prior to the conditions for initiating handover being met.

The user apparatus may be further configured to receive from the source network apparatus a list of autonomous target network apparatuses, the list comprising an indication of which target network apparatuses have not (even partially) configured any radio resources to the user apparatus for autonomous user apparatus handover (for example, when no (full or partial) RRCConnectionReconfiguration is included). The user apparatus may be configured to use this list to determine whether or not to initiate handover to a particular target network apparatus.

In an example, the user apparatus may be further configured to receive from the source network apparatus a list of autonomous target network apparatuses. The list may comprise an indication of which target network apparatuses are prepared for an autonomous handover by the user apparatus and/or an indication of which target network apparatuses are not prepared.

In a further example, the list may comprise an indication of what levels of information (i.e. full, partial or none) is provided in connection to autonomous handover operation by each target network apparatus.

The user apparatus may be configured to use different triggering criteria for triggering autonomous handover to the target network apparatus in dependence on the received indication. For example, different handover triggering criteria may be used depending on the preparation level (none, partial, full) of the target network apparatus. As one example, the user apparatus may be configured to more readily initiate handover when a full radio resource control configuration is received relative to when a partial radio resource control configuration or no radio resource control configuration is received. By extension, the user apparatus may be configured to more readily initiate handover when a partial radio resource control configuration is received relative to when no radio resource control configured is received.

Some example of different triggering criteria are now given. These are examples are merely exemplary, and other triggering criteria are also possible. As one example, the user apparatus may be configured to use different thresholds or time-to-trigger (or similar timer) configurations for different types of received radio resource control configurations. Also, depending on the on-going traffic, the user apparatus may be configured to prioritize (fully) prepared cells for handover to minimize interruption time provided that there is good enough (fully) prepared cells available. As mentioned above, a fully prepared cell refers to the target network apparatus that provides a full/complete radio resource control configuration for the user apparatus whilst a prepared cell refers to a target network apparatus that provides at least a partial radio resource control configuration.

The user apparatus may be configured to receive the indication after an autonomous handover procedure to the target network apparatus has already been initiated by the user apparatus.

In an example, the source network apparatus may be configured to signal to the user apparatus a list of autonomous handover target network apparatuses. The list may indicate to user apparatus, as mentioned above, which/that target network apparatus is prepared, and/or which target network apparatuses are not prepared.

Allowing partial/no radio resource control configuration for the target network apparatus signalled to the user apparatus with the autonomous handover configuration has the following advantages:
Partial radio resource control configuration allows support of contention-less RA procedure in the target network apparatus;
Partial radio resource control configuration does not require the user apparatus to read the system information of the target network apparatus before initiating an autonomous handover procedure, which reduces handover time; and
Less resource pooling is required in the target network apparatus and less information storage is required in the user apparatus than in the event that a full/complete configuration is made by the target network apparatus. This “Light” handover preparation can be useful e.g. in cases the target network apparatus is highly loaded and prefers avoiding reservation of radio resources (e.g. physical uplink control channel) for autonomous handover.

The user apparatus may still be required to receive from the target network apparatus a message (similar to, but not restricted to) radioResourceConfigDedicated (used in some LTE-type systems) after having sent an autonomous handover request message (similar or same as RRCConnectionReestablishmentRequest message) to the target network apparatus.

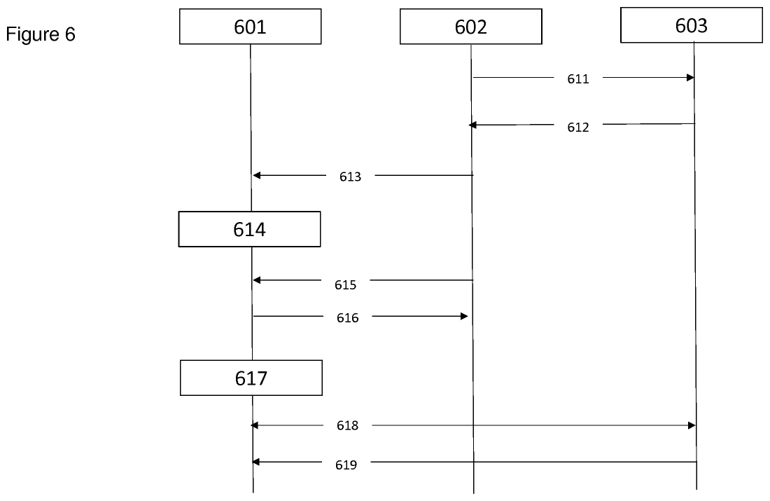

The signaling impact of different levels of radio resource control configuration for the potential handover target network apparatuses is further illustrated in FIGS. 6 to 8, and discussed below.

FIG. 6 is a signaling diagram between a user apparatus 601, a source network apparatus 602, and a target network apparatus 603 in the case that the target network apparatus 603 provides full a complete radio resource control configuration in response to an autonomous handover request from the source network apparatus 602.

Thus, at 611, the source network apparatus transmits an autonomous handover request to the target network apparatus 603. In response to this request, the target network apparatus transmits at 612 an autonomous handover request acknowledgement. This acknowledgment comprises a full/complete radio resource control configuration that is suitable for use by a user apparatus 601 when autonomously initiating handover.

At 613, the source network apparatus 602 transmits an autonomous handover configuration to the user apparatus 601. The autonomous handover configuration comprises the full radio resource control configuration provided by the target network apparatus 603 in 612.

The user apparatus 601 may then, at 614, determine that handover to the target network apparatus is to be performed. This determination may be the result of a trigger condition being fulfilled.

Optionally, at 615 the source network apparatus 602 may be configured to provide the user apparatus with an uplink allocation. At 616, in response to receipt of this uplink allocation, the user apparatus 601 may be configured to provide an indication to the source network apparatus 602 that handover to the target network apparatus 603 has been triggered. This indication may be provided in the form of a measurement report from the user apparatus 601 to the source network apparatus 602.

At 617, the user apparatus 601 is configured to detach from the source network apparatus 602 and synchronize to the transmissions of the target network apparatus 603.

Thus, at 618, the user apparatus 601 and the target network apparatus 603 utilize random access techniques for providing the user apparatus 601 with access to the target network apparatus 603.

At 619, the user apparatus 601 transmits a RadioConnectionReconfigurationComplete message or the like to the target network apparatus 603. The RadioConnectionReconfigurationComplete message is a message type that is currently in use in the radio resource control protocol. Its specific mention here is simply to provide an illustrative example of a message that may be used to indicate that a connection has been set up between the user apparatus and the target apparatus.

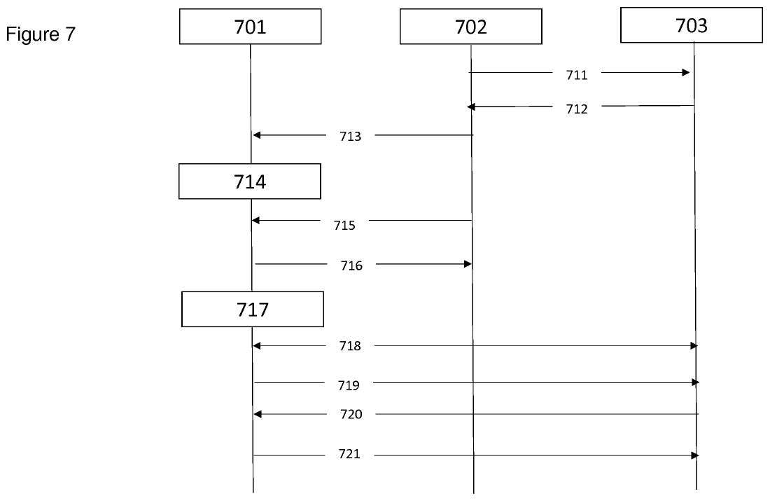

FIG. 7 is a signaling diagram between a user apparatus 701, a source network apparatus 702, and a target network apparatus 703 in the case that the target network apparatus 703 provides only a partial radio resource control configuration in response to an autonomous handover request from the source network apparatus 702.

Thus, at 711, the source network apparatus transmits an autonomous handover request to the target network apparatus 703. In response to this request, the target network apparatus transmits at 712 an autonomous handover request acknowledgement. This acknowledgment comprises a partial radio resource control configuration that is suitable for use by a user apparatus 701 when autonomously initiating handover.

At 713, the source network apparatus 702 transmits an autonomous handover configuration to the user apparatus 701. The autonomous handover configuration comprises the partial radio resource control configuration provided by the target network apparatus 703 in 712.

The user apparatus 701 may then, at 714, determine that handover to the target network apparatus is to be performed. This determination may be the result of a trigger condition being fulfilled.

Optionally, at 715 the source network apparatus 702 may be configured to provide the user apparatus with an uplink allocation. At 716, in response to receipt of this uplink allocation, the user apparatus 701 may be configured to provide an indication to the source network apparatus 702 that handover to the target network apparatus 703 has been triggered. This indication may be provided in the form of a measurement report from the user apparatus 701 to the source network apparatus 702.

At 717, the user apparatus 701 is configured to detach from the source network apparatus 702 and synchronize to the transmissions of the target network apparatus 703.

Thus at 718, the user apparatus 701 and the target network apparatus 703 utilize random access techniques for providing the user apparatus 701 with access to the target network apparatus 703.

At 719, the user apparatus 701 transmits an autonomous handover request to the target network apparatus 703. The autonomous handover request comprises ID information, such as a user apparatus identity and an identity of the source network apparatus 702.

In response to this autonomous handover request, the target network apparatus may transmit an autonomous handover accept message at 720. The handover accept message may comprise a complete radio resource configuration for the user apparatus 701 to use in communications with the target network apparatus 703. Alternatively at 720, the target network apparatus may issue a message rejecting the autonomous handover request.

In response to an accept message being sent at 720, at 721 the user apparatus 701 is configured to transmit an autonomous handover complete message to the target network apparatus 703, such as in 619.

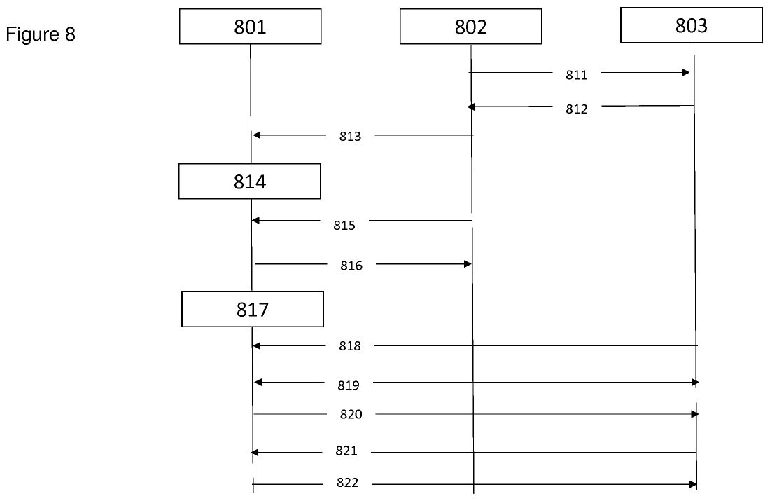

FIG. 8 is a signaling diagram between a user apparatus 801, a source network apparatus 802, and a target network apparatus 803 in the case that the target network apparatus 803 provides no radio resource control configuration in response to an autonomous handover request from the source network apparatus 802.

Thus, at 811, the source network apparatus transmits an autonomous handover request to the target network apparatus 803. In response to this request, the target network apparatus transmits at 812 an autonomous handover request acknowledgement. This acknowledgment does not comprise any radio resource control configuration that is suitable for use by a user apparatus 801 when autonomously initiating handover with the target network apparatus.

At 813, the source network apparatus 802 transmits an autonomous handover configuration to the user apparatus 801. The autonomous handover configuration does not comprise any radio resource control configuration for use by the user apparatus 801 when initiating handover with the target network apparatus 803.

The user apparatus 801 may then, at 814, determine that handover to the target network apparatus is to be performed. This determination may be the result of a trigger condition being fulfilled.

Optionally, at 815 the source network apparatus 802 may be configured to provide the user apparatus with an uplink allocation. At 816, in response to receipt of this uplink allocation, the user apparatus 801 may be configured to provide an indication to the source network apparatus 802 that handover to the target network apparatus 803 has been triggered. This indication may be provided in the form of a measurement report from the user apparatus 801 to the source network apparatus 802.

At 817, the user apparatus 801 is configured to detach from the source network apparatus 802 and synchronize to the transmissions of the target network apparatus 803.

Thus, at 818, the user apparatus is configured to acquire information regarding the target network apparatus 803 for synchronisation from a system information message broadcast by the target network apparatus 803.

At 819 the user apparatus 801 and the target network apparatus 803 utilize random access techniques for providing the user apparatus 801 with access to the target network apparatus 803. These random access techniques are based on information received in the system information broadcast.

At 820, the user apparatus 801 transmits an autonomous handover request to the target network apparatus 803. The autonomous handover request comprises ID information, such as a user apparatus identity and an identity of the source network apparatus 802.

In response to this autonomous handover request, the target network apparatus may transmit an autonomous handover accept message at 821 to the user apparatus 801. The handover accept message may comprise a complete radio resource configuration for the user apparatus 801 to use in communications with the target network apparatus 803. Alternatively at 821, the target network apparatus 803 may transmit a message to the user apparatus 801 rejecting the autonomous handover request.

In response to an accept message being sent at 821, at 822 the user apparatus 801 is configured to transmit an autonomous handover complete message to the target network apparatus 803, such as in 619.

Thus it can be seen in FIGS. 6 to 8 that the amount of signalling used for effecting a handover to a target network apparatus is less for cases in which a complete radio resource configuration is provided in advance to the user apparatus, relative to the partial and no radio resource control configuration cases. Further, the amount of signalling used for effecting a handover to a target network apparatus is less for cases in which a partial radio resource configuration is provided in advance to the user apparatus, relative to the no radio resource control configuration cases. Thus handover may be effected faster for the full configuration case than for the partial and no configuration cases, and the partial configuration case may be associated with a faster handover time than the no configuration case. A faster handover procedure provides a better quality of service to the user apparatus.

In the above, reference is made to both “full”/“complete” and “partial” radio resource control configuration information. These concepts are discussed further below.

In general, the term radio resource control configuration information refers to information regarding resources that have been reserved by the target network apparatus for at least use when accessing the target network apparatus during a handover procedure i.e. when establishing a connection with the target network apparatus. The resources may thus be dedicated resources. However, it is understood that a target network apparatus may reserve the same resources for multiple user apparatuses, depending on the network configuration.

In a more specific case, the radio resource control configurations are defined in accordance with the radio resource control protocol (currently in use (and defined separately) for LTE (see 3GPP TS 36.331) and UMTS (see 3GPP TS 25.331)). The radio resource control protocol is a layer that exists at the Internet Protocol level and may be used for establishing connections, releasing connections, broadcasting system information, establishing radio bearers, reconfiguring and/or releasing radio bearers, and other similar functions.

The exact form of these resources is determined in accordance with the exact radio resource control communication protocol the user apparatus and the target network apparatus are configured to use for communication with each other. Resources for this purpose may be configured by the target network apparatus in whole or in part. This may be understood with reference to the communication protocol being used (as mentioned above). For example, the communication protocol may define a set of resources/information that must be used for communications between a user apparatus and a target network apparatus (e.g. number of resources, type of resources, etc.). The preconfigured radio resource control configuration information may comprise all of these such resources (i.e. it is a “full” or “complete” radio resource configuration), or the preconfigured radio resource control information may only comprise a subset of this set of resources (i.e. it is a “partial” radio resource configuration). It is also understood that the target network apparatus may choose to not allocate any resources for handover purposes in advance of an actual handover event being triggered.

Throughout the above, the terms “network apparatus” and “cell” are used interchangeably, as a network apparatus may define a coverage area of at least one cell through the maximum range of its transmissions.

Further, the terms “source network apparatus” and “target network apparatus” are used above to denote access points to a network (or a part thereof), the source network apparatus being an access point used by the user apparatus prior to a handover request being made and the target network apparatus being an access point to which the user apparatus attempts to access the network via subsequent to the handover request being made.

It should be understood that each block of the flowchart of the Figures and any combination thereof may be implemented by various means or their combinations, such as hardware, software, firmware, one or more processors and/or circuitry.

It is noted that whilst embodiments have been described in relation to one example of a standalone LTE networks, similar principles maybe applied in relation to other examples of standalone 3G, LTE or 5G networks. It should be noted that other embodiments may be based on other cellular technology other than LTE or on variants of LTE. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1.-21. (canceled)

22. An apparatus, comprising:
at least one processor; and
at least one memory including computer program code,
the at least one memory and the computer program code configured to, with the at least one processor, cause the apparatus at least to:
transmit to a target network apparatus prior to the target network apparatus receiving a message for initiating handover of a user apparatus to the target network apparatus, a request for a radio resource control configuration for use by the user apparatus when accessing the target network apparatus;
receive a response to the request; and
forward, to the user apparatus, at least part of any radio resource control configuration information comprised in the response.

23. An apparatus, comprising:
at least one processor; and
at least one memory including computer program code,
the at least one memory and the computer program code configured to, with the at least one processor, cause the apparatus at least to:
receive a request from a source network apparatus for a radio resource control configuration for use by a user apparatus when accessing the target network apparatus;
determine, by the target network apparatus, whether or not to configure at least a partial radio resource control configuration for the user apparatus in a response to the request; and
transmit a response to the request in dependence on the determining.

24. An apparatus, comprising:
at least one processor; and
at least one memory including computer program code,
the at least one memory and the computer program code configured to, with the at least one processor, cause the apparatus at least to:
receive from a source network apparatus, an indication of a type of radio resource control configuration information for use by the apparatus when accessing a target network apparatus; and
selecting a signalling procedure to access the target network apparatus in dependence on the indication.

25. The apparatus as claimed in claim 24, wherein the indication comprises one of:
a complete radio resource control configuration;
a partial radio resource control configuration; and
no radio resource control configuration.

26. The apparatus as claimed in claim 25, wherein the at least one memory and the computer program code are further configured to, with the at least one processor, cause the apparatus to:
if the indication comprises the complete radio resource control configuration:
perform random access on at least some of the resources included in the indication; and
transmit a radio resource control connection reconfiguration complete message to the target network apparatus,
else
if the indication comprises the partial radio resource control configuration:
perform random access on at least some of the resources included in the indication; and
transmit a radio resource control connection establishment request message to the target network apparatus,
else
if the indication comprises no radio resource control configuration:
perform random access on at least some of the resources indicated in a system information broadcast by the target network apparatus; and
transmit a radio resource control connection establishment request message to the target network apparatus.

27. The apparatus as claimed in claim 24, wherein the at least one memory and the computer program code are further configured to, with the at least one processor, cause the apparatus to:
determine that criteria for autonomous handover to the target network apparatus has been fulfilled subsequent to said receiving; and
perform said selecting in dependence on said determining.

28. The apparatus as claimed in claim 24, wherein the at least one memory and the computer program code are further configured to, with the at least one processor, cause the apparatus to:
receive from the source network apparatus a list of autonomous target network apparatuses, the list comprising an indication of which target network apparatuses have not configured any radio resources to the user apparatus for autonomous user apparatus handover.

29. The apparatus as claimed in claim 24, wherein the at least one memory and the computer program code are further configured to, with the at least one processor, cause the apparatus to:
use different triggering criteria for triggering autonomous handover to the target network apparatus in dependence on the received indication.

30. The apparatus as claimed claim 24, wherein the at least one memory and the computer program code are further configured to, with the at least one processor, cause the apparatus to:
receive the indication after an autonomous handover procedure to the target network apparatus has already been initiated by the user apparatus.

31. A method, comprising:
receiving, by a user apparatus from a source network apparatus, an indication of a type of radio resource control configuration information for use by the user apparatus when accessing a target network apparatus; and
selecting a signalling procedure to access the target network apparatus in dependence on the indication.

32. The method as claimed in claim 31, wherein the indication comprises one of:
a complete radio resource control configuration;
a partial radio resource control configuration; and
no radio resource control configuration.

33. The method as claimed in claim 32, further comprising:
if the indication comprises the complete radio resource control configuration:
performing random access on at least some of the resources included in the indication; and
transmitting a radio resource control connection reconfiguration complete message to the target network apparatus,
else
if the indication comprises the partial radio resource control configuration:
performing random access on at least some of the resources included in the indication; and
transmitting a radio resource control connection establishment request message to the target network apparatus,
else
if the indication comprises no radio resource control configuration:
performing random access on at least some of the resources indicated in a system information broadcast by the target network apparatus; and
transmitting a radio resource control connection establishment request message to the target network apparatus.

34. The method as claimed in claim 31, further comprising:
determining that criteria for autonomous handover to the target network apparatus has been fulfilled subsequent to said receiving; and
performing said selecting in dependence on said determining.

35. The method as claimed in claim 31, further comprising receiving from the source network apparatus a list of autonomous target network apparatuses, the list comprising an indication of which target network apparatuses have not configured any radio resources to the user apparatus for autonomous user apparatus handover.

36. The method as claimed in claim 31, further comprising using different triggering criteria for triggering autonomous handover to the target network apparatus in dependence on the received indication.

37. The method as claimed in claim 31, further comprising receiving the indication after an autonomous handover procedure to the target network apparatus has already been initiated by the user apparatus.

38. A computer program product embodied on a non-transitory computer-readable storage medium bearing computer program code embodied therein, said computer program code, causing a computer to perform the method of claim 31 when the computer program product is run on the computer.
